(19) United States
(12) Patent Application Publication
(10) Pub. No.: US 2012/0019215 A1
(43) Pub. Date: Jan. 26, 2012

(54) METHOD FOR CHARGING MULTIPLE RECHARGEABLE ENERGY STORAGE SYSTEMS AND RELATED SYSTEMS AND METHODS

(75) Inventors: Craig K. Wenger, Chandler, AZ (US); Donald B. Karner, Phoenix, AZ (US); Garrett Beauregard, Phoenix, AZ (US)

(73) Assignee: Electric Transportation Engineering Corp., D/b/a ECOtality North America, Phoenix, AZ (US)

(21) Appl. No.: 13/207,363

(22) Filed: Aug. 10, 2011

Related U.S. Application Data
(63) Continuation-in-part of application No. PCT/US2011/037587, filed on May 23, 2011.
Application No. PCT/US2011/037587 is a continuation-in-part of application No. PCT/US2011/034667, filed on Apr. 29, 2011.
Application No. PCT/US2011/034667 is a continuation-in-part of application No. PCT/US2011/037588, filed on May 23, 2011.
Application No. PCT/US2011/037588 is a continuation-in-part of application No. PCT/US2011/034667, filed on Apr. 29, 2011.
Application No. PCT/US2011/034667 is a continuation-in-part of application No. 13/174,470, filed on Jun. 30, 2011.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.

(51) Int. Cl. H02J 7/00

(52) U.S. Cl. 320/149

(57) ABSTRACT

Some embodiments include a method for charging multiple rechargeable energy storage systems. Other embodiments or related systems and methods are disclosed.

### CROSS-REFERENCE TO RELATED APPLICATIONS

This application is a continuation-in-part of PCT Application No. PCT/US2011/037587, filed May 23, 2011, which claims the benefit of (i) U.S. Provisional Application No. 61/367,316, filed Jul. 23, 2010; (ii) U.S. Provisional Application No. 61/367,321, filed Jul. 23, 2010; (iii) U.S. Provisional Application No. 61/367,337, filed Jul. 23, 2010; and (iv) U.S. Provisional Application No. 61/367,317, filed Jul. 23, 2010. Furthermore, PCT Application No. PCT/US2011/037587 is a continuation-in-part of PCT Application No. PCT/US2011/034667, filed Apr. 29, 2011, which also claims the benefit of U.S. Provisional Application No. 61/367,316; U.S. Provisional Application No. 61/367,321; U.S. Provisional Application No. 61/367,337; and U.S. Provisional Application No. 61/367,317.

This application further is a continuation-in-part of PCT Application No. PCT/US2011/037588, filed May 23, 2011, which claims the benefit of (i) U.S. Provisional Application No. 61/367,316, filed Jul. 23, 2010; (ii) U.S. Provisional Application No. 61/367,321, filed Jul. 23, 2010; (iii) U.S. Provisional Application No. 61/367,337, filed Jul. 23, 2010; and (iv) U.S. Provisional Application No. 61/367,317, filed Jul. 23, 2010. Furthermore, PCT Application No. PCT/US2011/037588 is a continuation-in-part of PCT Application No. PCT/US2011/034667, filed Apr. 29, 2011, which also claims the benefit of U.S. Provisional Application No. 61/367,316; U.S. Provisional Application No. 61/367,321; U.S. Provisional Application No. 61/367,337; and U.S. Provisional Application No. 61/367,317.

Furthermore, this application is a continuation-in-part of U.S. Non-Provisional application Ser. No. 13/174,470, filed Jun. 30, 2011.

The disclosures of PCT Application No. PCT/US2011/037587; PCT Application No. PCT/US2011/037588; PCT Application No. PCT/US2011/034667; U.S. Non-Provisional Application No. 13/174,470; U.S. Provisional Application No. 61/367,316; U.S. Provisional Application No. 61/367,321; U.S. Provisional Application No. 61/367,317; and U.S. Provisional Application No. 61/367,337 are incorporated herein by reference.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to methods for charging multiple rechargeable energy storage systems, and relates more particularly to methods for charging multiple rechargeable energy storage systems based on current throughputs corresponding to the multiple rechargeable energy storage systems and related systems and methods.

### DESCRIPTION OF THE BACKGROUND

Unlike refueling internal combustion powered vehicles, which may take only minutes, charging rechargeable energy storage systems of electric powered vehicles, referenced herein as “electric vehicles,” may take considerably longer amounts of time. Meanwhile, in many charging applications, particularly with respect to industrial electric vehicles, a single electric vehicle charging station may be responsible for concurrently charging multiple rechargeable energy storage systems of multiple electric vehicles. As a result, increasing the efficiency with which electric vehicle charging stations charge rechargeable energy storage systems is becoming increasingly important both to electric vehicle operators wanting timely use of their electric vehicles and to electric vehicle charging station operators wanting to maximize use of their electric vehicle charging stations to thereby maximize profitability. Concerns for efficient charging are further enhanced by increasing electricity costs both to consumers and vendors alike.

Accordingly, a need or potential for benefit exists for methods and systems improving the efficiency with which multiple rechargeable energy storage systems can be charged. Where possible, an additional need or potential for benefit exists where these methods and systems can be extended beyond rechargeable energy storage systems for electric vehicles to rechargeable energy storage systems generally.

### BRIEF DESCRIPTION OF THE DRAWINGS

To facilitate further description of the embodiments, the following drawings are provided in which:

FIG. 1 illustrates a control system for charging multiple rechargeable energy storage systems, according to an embodiment;

FIG. 2 illustrates a computer system that is suitable for implementing an embodiment of a control computer system and/or a central computer system of FIG. 1; and

FIG. 3 illustrates a representative block diagram of an example of the elements included in the circuit boards inside a chassis of the computer system of FIG. 2.

FIG. 4 illustrates a flow chart for an embodiment of a method for charging multiple rechargeable energy storage systems;

FIG. 5 illustrates a flow chart for an exemplary embodiment of a procedure of determining current throughputs of the multiple rechargeable energy storage systems, according to the embodiment of FIG. 4;

FIG. 6 illustrates a flow chart for an exemplary embodiment of a procedure of charging the multiple rechargeable energy storage systems according to another charge protocol, according to the embodiment of FIG. 4.;

FIG. 7 illustrates a flow chart for an embodiment of a method of providing a control system for charging multiple rechargeable energy storage systems; and

FIG. 8 illustrates an exemplary embodiment of a control system operating to charge multiple rechargeable energy storage systems.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “mobile electronic device” as used herein refers to at least one of a digital music player, a digital video player, a digital music and video player, a cellular phone (e.g., smartphone), a personal digital assistant, a handheld digital computer, or another device with the capability to display images and/or videos. For example, a mobile electrical device can comprise the iPod® or iPhone® or iTouch® or iPad® product by Apple Inc. of Cupertino, Calif. Likewise, a mobile electrical device can comprise a Blackberry® product by Research in Motion (RIM) of Waterloo, Ontario, Canada, or a different product by a different manufacturer.

The term “computer network” is defined as a collection of computers and devices interconnected by communications channels that facilitate communications among users and allows users to share resources (e.g., an internet connection, an Ethernet connection, etc.). The computers and devices can be interconnected according to any conventional network topology (e.g., bus, star, tree, linear, ring, mesh, etc.).

### DETAILED DESCRIPTION OF EXAMPLES OF EMBODIMENTS

Some embodiments include a method for charging multiple rechargeable energy storage systems. The method can comprise: determining current throughputs of the multiple rechargeable energy storage systems; and if a first current throughput of a first one of the multiple rechargeable energy storage systems is greater than one or more current throughputs corresponding to one or more other ones of the multiple rechargeable energy storage systems, charging the first one of the multiple rechargeable energy storage systems at the first current throughput until a first predetermined condition is met.

Various embodiments include a control system for charging multiple rechargeable energy storage systems. The control system comprises a communication module configured to determine current throughputs of the multiple rechargeable energy storage systems. The control system comprises a control module configured to communicate with the communication module and a charge system. The control module is configured to control the charge system such that, if the first current throughput of the first one of the multiple rechargeable energy storage systems is greater than one or more current throughputs of one or more other ones of the multiple rechargeable energy storage systems, the charge system charges a first one of the multiple rechargeable energy storage systems at a first current throughput until a first predetermined condition is met.

Further embodiments include a method of providing a control system for charging multiple rechargeable energy storage systems. The method can comprise: providing a communication module configured to determine current throughputs of the multiple rechargeable energy storage systems; and providing a control module configured to communicate with the communication module and a charge system and configured to control the charge system such that, if a first current throughput of a first one of the multiple rechargeable energy storage systems is greater than one or more current throughputs of one or more other ones of the multiple rechargeable energy storage systems, the charge system charges the first one of the multiple rechargeable energy storage systems at the first current throughput until a first predetermined condition is met.

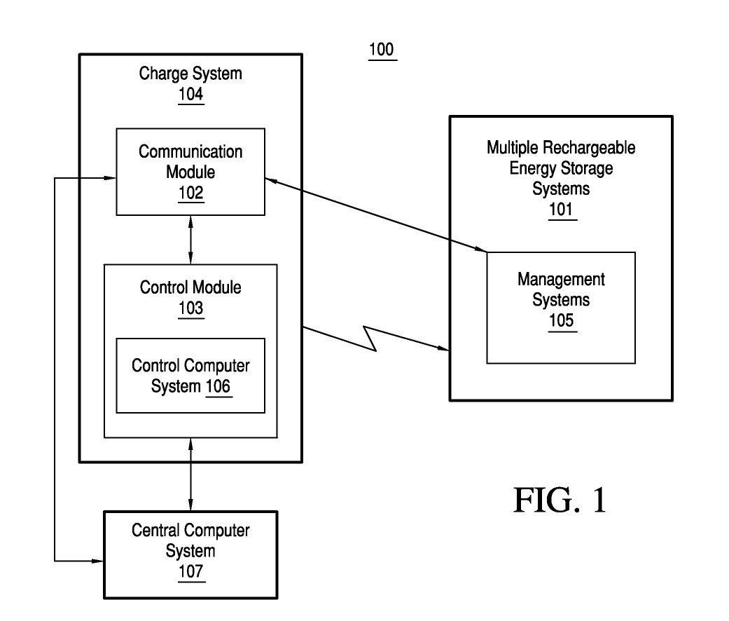

Turning to the drawings, FIG. 1 illustrates a block diagram of control system 100 for charging multiple rechargeable energy storage systems 101, according to an embodiment. Control system 100 is merely exemplary and is not limited to the embodiments presented herein. Control system 100 can be employed in many different embodiments or examples not specifically depicted or described herein. As used herein, the term “charging” refers to both charging and/or recharging, as applicable.

In some embodiments, each rechargeable energy storage system of multiple rechargeable energy storage systems 101 can be configured to provide electricity to an electronic device. In many embodiments, the electronic device can comprise an electric vehicle. In other embodiments, the electronic device can comprise any other device configured to receive electricity. For example, the electronic device can be a mobile electronic device, as described above.

In the same or different embodiments, each rechargeable energy storage system of multiple rechargeable energy storage systems 101 can comprise (a) one or more batteries and/or one or more fuel cells, (b) one or more capacitive energy storage systems (e.g., super capacitors such as electric double-layer capacitors), and/or (c) one or more inertial (e.g., flywheel) energy storage systems. In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery such as a gel battery and/or an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) battery and/or a lithium (e.g., lithium-ion (Li-ion)) battery. In some embodiments, where the rechargeable energy storage system comprises more than one battery, the batteries can all comprise the same type and/or size of battery. In other embodiments, where the rechargeable energy storage system comprises more than one battery, the batteries can comprise at least two different types and/or sizes of batteries. In many embodiments, the at least one fuel cell can comprise at least one hydrogen fuel cell.

Meanwhile, where the electronic device described above with respect to multiple rechargeable energy storage systems 101 comprises an electric vehicle, the electric vehicle can comprise a full electric vehicle and/or any other grid-connected vehicle. For example, the electric vehicle can comprise a car, a truck, motorcycle, a bicycle, a scooter, a boat, a train, an aircraft, an airport ground support equipment, and/or a material handling equipment (e.g., a fork-lift), etc. In some embodiments, the electric vehicle can comprise a passenger vehicle, a commercial vehicle, and/or an industrial vehicle.

Additionally, where the electronic device described above with respect to multiple rechargeable energy storage systems 101 comprises an electric vehicle, the charge system(s) (e.g., charge system 104), described below, can comprise electric vehicle charging station(s). Accordingly, in some embodiments, the electric vehicle charging station(s) can comprise personal and/or commercial electric vehicle supply equipment. In other embodiments, the electric vehicle charging station(s) can comprise industrial electric vehicle supply equipment (e.g., on-board AC electric charger(s), off-board DC electric charger(s)). Whether being configured for personal, commercial, and/or industrial applications, the electric vehicle charging station(s) can be configured to provide electricity to multiple rechargeable energy storage systems 101 by conductive and/or inductive electricity transfer.

Personal and/or commercial electric vehicle supply equipment can comprise level 1 electric vehicle supply equipment, level 2 electric vehicle supply equipment, and/or level 3 electric vehicle supply equipment. Level 1 electric vehicle supply equipment can comprise either of level 1 alternating current (AC) electric vehicle supply equipment or level 1 direct current (DC) electric vehicle supply equipment. Meanwhile, level 2 electric vehicle supply equipment can comprise either of level 2 AC electric vehicle supply equipment or level 2 DC electric vehicle supply equipment. Furthermore, level 3 electric vehicle supply equipment can comprise either of level 3 AC electric vehicle supply equipment or level 3 DC electric vehicle supply equipment. In some embodiments, each level 2 electric vehicle supply equipment and/or level 3 electric vehicle supply equipment can also be referred to as a fast charger. In many embodiments, each personal and/or commercial electric vehicle supply equipment can be configured to provide electricity comprising a maximum electric current of 30 amperes (A) or 48 A. When the maximum electric current of the personal and/or commercial electric vehicle supply equipment comprises 30 A, that electric vehicle supply equipment can be configured to provide electricity comprising an electric current of one or more of 12 A, 16 A, or 24 A. When the maximum electric current of the personal and/or commercial electric vehicle supply equipment comprises 48 A, that electric vehicle supply equipment can be configured to provide electricity comprising an electric current of one or more of 12 A, 16 A, 24 A, or 30 A.

For example, each level 1 AC electric vehicle supply equipment can be configured to provide electricity comprising an electric voltage of approximately 120 volts (V) and an electric current: (a) greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, level 1 electric vehicle supply equipment can comprise one or more standard grounded domestic electrical outlet(s). Meanwhile, each level 2 AC electric vehicle supply equipment can be configured to provide electricity comprising an electric voltage greater than or equal to approximately 208 V and less than or equal to approximately 240 V, and an electric current greater than or equal to approximately 0 A and less than or equal to approximately 80 A AC. Furthermore, each level 3 AC electric vehicle supply equipment can be configured to provide electricity comprising an electric voltage greater than or equal to approximately 208 V, and an electric current greater than or equal to approximately 80 A AC (e.g., 240 V AC (single phase), 208 V AC (triple phase), 480 V AC (triple phase). In some embodiments, the electric voltages for level 1 electric vehicle supply equipment, level 2 electric vehicle supply equipment, and/or level 3 electric vehicle supply equipment can be within plus or minus (±) ten percent (%) tolerances of the electric voltages provided above.

In other examples, each level 1 DC electric vehicle supply equipment can be configured to provide electricity comprising electric power greater than or equal to approximately 0 kiloWatts (kW) and less than or equal to approximately 19 kW. Meanwhile, each level 2 DC electric vehicle supply equipment can be configured to provide electricity comprising electric power greater than or equal to approximately 19 kW and less than or equal to approximately 90 kW. Furthermore, each level 3 DC electric vehicle supply equipment can be configured to provide electricity comprising electric power greater than or equal to approximately 90 kW. In some embodiments, the term fast charger can refer to personal and/or commercial electric vehicle supply equipment that is configured to provide electricity comprising an electric voltage between approximately 300 V-500 V and an electric current between approximately 100 A-400 A DC.

Industrial electric vehicle supply equipment (e.g., on-board AC electric charger(s), off-board DC electric charger(s) can be configured to provide electricity comprising electric power greater than or equal to approximately 3 kW and less than or equal to approximately 33 kW. Off-board DC electric charger can be configured to provide electricity comprising an electric voltage greater than or equal to approximately 18 V DC and less than or equal to approximately 120 V DC.

Referring now back to FIG. 1, control system 100 comprises communication module 102 and control module 103. Control system 100 can comprise charge system 104. In some embodiments, charge system 104 can comprise communication module 102 and/or control module 103. Control system 100 can comprise control computer system 106, and control module 103 can comprise control computer system 106. In some embodiments, control system 100 can comprise central computer system 107. Meanwhile, in some embodiments, control system 100 can comprise multiple rechargeable energy storage systems 101, and multiple rechargeable energy storage systems 101 can comprise management systems 105. In particular, each rechargeable energy storage system can comprise its own management system.

Control module 103 is configured to communicate with communication module 102 and/or charge system 104. For example, control module 103 can be configured to communicate with communication module 102 and/or charge system 104 via a wired connection (e.g., an electrical bus connection, an Ethernet connection, a Powerline connection, etc.) and/or a wireless connection (e.g., (1) any suitable wireless computer network connection, for example, an 802.11 wireless local area network (WLAN) connection, a Bluetooth connection, and the like, (2) any suitable cellular telephone network connection, for example, a code division multiple access (CDMA) (e.g., IS-95) network, a global system for mobile communications (GSM) network, a time division multiple access (TDMA) network, and/or an orthogonal frequency-division multiplexing (OFDM) network, and the like, and (3) any other suitable wireless connection medium).

Communication module 102 can be configured to communicate with management systems 105. For example, communication module 102 can be configured to communicate with management systems 105 in a similar or identical manner to the manner in which control module 103 communicates with communication module 102 and/or charge system 104.

Control system 100 and/or control module 103 can be configured to communicate with control computer system 106 and/or central computer system 107. For example, control system 100 and/or control module 103 can be configured to communicate with control computer system 106 and/or central computer system 107 in a similar or identical manner to the manner in which control module 103 communicates with communication module 102 and/or charge system 104.

Through the functionality of communication module 102 and/or control module 103, control system 100 can be configured to charge multiple rechargeable energy storage systems 101 by controlling one or more charge systems (e.g., charge system 104) according to one or more charging protocols, as will be expanded upon below. More specifically, communication module 102 can be configured to analyze multiple rechargeable energy storage systems 101 according to the present charging protocol.

For example, under a “current throughput” charge protocol, as will be discussed in greater detail below, communication module 102 can analyze current throughputs of some and/or all of multiple rechargeable energy storage systems 101. Based on the results of the analysis performed by communication module 102, communication module 102 and/or control module 103 can determine whether multiple rechargeable energy storage systems 101 can be (or should be) charged according to the present charging protocol. If so, control module 103 can then proceed to control the charge system(s) (e.g., charge system 104) such that the charge system(s) charge one or more rechargeable energy storage system(s) of multiple rechargeable energy storage systems 101. If not, control system 100 can cycle through additional charging protocols, whereby communication module 102 and control module 103 can repeat the above functionality according to each successive charging protocol until communication module 102 and/or control module 103 arrive upon a charging protocol by which multiple rechargeable energy storage systems 101 can be (or should be) charged.

In determining the charging protocol, in some embodiments, communication module 102 and/or control module 103 may consider the type(s) of electronic device(s) for which each rechargeable energy storage system of multiple rechargeable energy storage systems 101 is configured to provide electricity and/or may consider the type(s) of rechargeable energy storage systems of the multiple rechargeable energy storage systems 101. For example, communication module 102 and/or control module 103 may determine different charging protocols when the electronic device(s) comprise(s) one or more electric vehicles, as described above, depending on whether the electric vehicle(s) comprise one or more passenger vehicle(s), one or more commercial vehicle(s), and/or one or more industrial vehicle(s).

When a suitable charging protocol is established by communication module 102 and/or control module 103 and when control module 103 begins controlling the charge system(s) (e.g., charge system 104) such that the charge system(s) begin charging multiple rechargeable energy storage systems 101, control module 103 can continue in this manner until one or more predetermined conditions are met. When any one of the predetermined conditions are met, control module 103 can be configured to control the charge system(s) (e.g., charge system 104) such that the control system(s) suspend charging multiple rechargeable energy storage systems 101. Upon suspension of the charge, a charging cycle can be said to have been completed.

With respect to the charging cycle, control system 100 can be configured to operate cyclically, repeating charge cycles until multiple rechargeable energy storage systems 101 can no longer receive or store additional electricity or where charging is no longer desired for any other reason. In many embodiments, the condition where multiple rechargeable energy storage systems 101 can no longer receive or store additional electricity can more specifically refer to a condition where multiple rechargeable energy storage systems 101 can no longer receive or store additional electricity efficiently as opposed to a condition where multiple rechargeable energy storage systems 101 literally cannot physically receive or store additional electricity.

In some embodiments, communication module 102 may continue to analyze multiple rechargeable energy storage systems 101 throughout the charge cycle. This situation can occur where the predetermined condition for ending the charge cycle needs to be monitored or detected (i.e., the predetermined condition is based on a property one or more rechargeable energy storage systems of multiple rechargeable energy storage systems 101). In other embodiments, communication module 102 may analyze only multiple rechargeable energy storage systems 101 at the start of each charge cycle. Such a configuration may be advantageous to minimize computing requirements.

The details provided below expand upon the functionality of control system 100. For exemplary purposes, these details are directed at embodiments of control system 100 implementing single charge system 104. Nonetheless, as described above, it should be understood that more complex embodiments of control system 100 can implement multiple charge systems comprising charge system 104. Whether implementing a single one of charge system 104 or implementing multiple charge systems, each comprising its own charge system 104, control system 100 can be configured to charge as many rechargeable energy storage systems 101 during any given charge cycle as there are charge systems (e.g., charge system 104) implemented by the given embodiment of control system 100. Accordingly, for some embodiments of control system 100 implementing a single one charge system 104, control system 100 can be configured to charge one rechargeable energy storage system of multiple rechargeable energy storage systems 101 during each charge cycle. In the same or different embodiments of control system 100, control system 100 can be configured to charge only one rechargeable energy storage system of multiple rechargeable energy storage systems 101 during each charge cycle.

As mentioned above, control system 100 can be configured to charge multiple rechargeable energy storage systems 101 by controlling charge system 104 according to one or more charging protocols. For example, one charge protocol for control system 100 can be a current throughput charge protocol. In many embodiments, charging multiple rechargeable energy storage systems 101 according to the current throughput charge protocol provides the maximum electric current to multiple rechargeable energy storage systems 101. That is to say, under the current throughput charge protocol, charge system 104 can be configured to provide as much electric current to charge multiple rechargeable energy storage systems 101 as multiple rechargeable energy storage systems 101 are able to receive and/or as charge system 104 is configured to provide. Accordingly, in many embodiments, current throughput can be understood to mean electric current acceptance.

Charging multiple rechargeable energy storage systems 101 according to the current throughput charge protocol can increase the efficiency (e.g., by maximizing total current throughput, by minimizing the electric power required to provide the electricity for the charge, etc.) with which multiple rechargeable energy storage systems 101 are charged. Indeed, charging multiple rechargeable energy storage systems 101 according to the current throughput charge protocol can be particularly advantageous where multiple rechargeable energy storage systems 101 demonstrate a poor correlation between current throughput and state of charge. For example, where multiple rechargeable energy storage systems 101 comprise one or more lead-acid batteries, a strong correlation between state of charge and current throughput can exist. However, where multiple rechargeable energy storage systems 101 comprise one or more Li-ion batteries, a given rechargeable energy storage system of multiple rechargeable energy storage systems 101 might not consistently have both the lowest state of charge and the greatest current throughput simultaneously. Specifically, heating effects during charging can cause current throughput in Li-ion batteries to decrease throughout the course of a charge. As a result, regardless of whether that Li-ion battery has a lower state of charge than another Li-ion battery, the first Li-ion battery may simply not be able to receive as much electric current (e.g., due to heating effects) as the second Li-ion battery. Accordingly, by switching the charge to the second Li-ion battery and permitting the first Li-ion battery to cool, charging according to the current throughput charge protocol can ultimately permit more overall electric current to be passed to multiple rechargeable energy storage systems 101, thereby making the overall charging process more efficient.

For example, when operating according to the current throughput charge protocol, communication module 102 can be configured to determine (e.g., analyze) current throughputs of multiple rechargeable energy storage systems 101, as described in greater detail below. If communication module 102 and/or control module 103 determine that one (e.g., a first one) of multiple rechargeable energy storage systems 101 exhibits an ability to receive more current throughput (e.g. a first current throughput) than one or more other ones of multiple rechargeable energy storage systems 101, control module 103 can control charge system 104 such that charge system 104 charges the one of multiple rechargeable energy storage systems 101 at the first or higher current throughput until a predetermined condition (e.g., a first predetermined condition is met). Control system 100 can repeat this process for additional ones (e.g., a second one) of multiple rechargeable energy storage systems 101 for each charge cycle. In some embodiments, the previously charged rechargeable energy storage system may be charged again in the next charge cycle if it remains able to accept the greatest current throughput. In other embodiments, a new or different rechargeable energy storage system may receive the charge in the subsequent charge cycle, such as where the current throughput of the previous rechargeable energy storage system has decreased below that of the first or previous rechargeable energy storage system being charged.

Other possible charge protocols that may be implemented by control system 100 can comprise a state of charge charge protocol, or any other suitable charge protocol. For example, where employing the state of charge charge protocol, control system 100 can tailor charging multiple rechargeable energy storage systems 101 around charging a rechargeable energy storage system of multiple rechargeable energy storage systems 101 having either of a lowest or greatest state of charge, where the term “state of charge” can refer to the present energy capacity of the given rechargeable energy storage system. Other suitable protocols may be related to other electrical properties (e.g., voltage) of multiple rechargeable energy storage systems 101 and/or to other concepts like a rank of priority selected by a user, a designated number of each rechargeable energy storage system, etc. The other concept charge protocols can help break ties where one or more of multiple rechargeable energy storage systems 101 are not currently distinguishable by their electrical properties (i.e., where one or more of multiple rechargeable energy storage systems 101 have approximately the same current throughput, state of charge, etc.) and, therefore, can be used with the current throughput charge protocol, etc.

As another example, control module 103 can be configured to control charge system 104 such that charge system 104 charges multiple rechargeable energy storage systems 101 according to another charge protocol (e.g., the state of charge charge protocol). In many embodiments, control module 103 can control charge system 104 such that charge system 104 charges multiple rechargeable energy storage systems 101 if the current throughputs are approximately equal and/or multiple rechargeable energy storage systems 101 remain able to be charged. In these embodiments, control module 103 can control charge system 104 according to the other charge protocol after control system 100 determines that multiple rechargeable energy storage systems 101 are not in a condition suitable for charging according to the current throughput charge protocol.

As mentioned above, control system 100 can be thought of as operating in stages within each charge cycle. For example, where communication module 102 determines that one or more rechargeable energy storage systems of multiple rechargeable energy storage systems 101 are undistinguishable (e.g., have the same current throughput, state of charge, etc.) with respect to one charge protocol, control system can move to another charge protocol. In many embodiments, control system 100 and/or communication module 102 can analyze multiple rechargeable energy storage systems 101 first according to the current throughput charge protocol. Next, control system 100 and/or communication module 102 can analyze multiple rechargeable energy storage systems 101 according to the state of charge charge protocol. Then, control system 100 and/or communication module 102 can analyze multiple rechargeable energy storage systems 101 according to any other suitable protocol, as referenced above. In other embodiments, control system 100 can be configured such that a user can select and/or order the charge protocol(s) via control computer system 106 and/or central computer system 107.

In many embodiments, the predetermined condition(s) (e.g., a first predetermined condition, a second predetermined condition, etc.) can comprise (1) the passing of a predetermined interval of time (e.g., 5-15 minutes), (2) the current throughput of a presently charging rechargeable energy storage system declining by a predetermined percentage (e.g., 5-20 percent (%)), (3) the current throughput of a presently charging rechargeable energy storage system declines by a predetermined amount (e.g., 10 Amps), (4) the current throughput approximately equals the next highest current throughput of another rechargeable energy storage system, and/or (5) another rechargeable energy storage system is added to the multiple rechargeable energy storage systems. Other suitable predetermined conditions also may be used. Likewise, equivalent predetermined conditions to those provided may be used for other charge protocols. For example, state of charge may replace current throughput in the predetermined conditions when the state of charge protocol is used. However, in such an example, the predetermined condition may have to be modified to correspond to the relevant property. In the case of state of charge, the condition may now focus on a percentage or amount increase of the state of charge, etc. The predetermined condition(s) may differ between charging protocols or may stay the same. One global predetermined condition for all the charging protocols may be where multiple rechargeable energy storage systems 101 are charged to capacity.

When the predetermined condition(s) comprise the passing of a predetermined interval of time, the predetermined interval of time can be greater than or equal to approximately five (5) minutes and less than or equal to approximately fifteen (15) minutes. In some embodiments, the predetermined interval of time can comprise eight (8) minutes. In general, this predetermined interval of time can be selected to be longer than a ramping up time of charge system 104, such that charge system 104 provides electricity for the charge at or near its maximum charge electric current. For example, charge system 104 may take twenty (20) seconds in some embodiments to ramp up to its maximum current. In some embodiments, the predetermined interval of time may also account for a ramping down time of charge system 104, or it may not be necessary to do so if the ramping down time is minimal (e.g., one (1) to three (3) seconds). Meanwhile, the predetermined interval of time may also be selected to be short enough such that the benefits of the optimization scheme can actually be applied to the charge.

In many embodiments, control system 100 can be configured such that a user of control system 100 can select the predetermined condition(s) via control computer system 106 and/or central computer system 107. In other embodiments, the predetermined condition can be preselected. In still other embodiments, the predetermined condition can be optimally selected for one or more charging protocols by control system 100, communication system 102, and/or control module 103.

After the predetermined condition is met, control system 100, control module 103, and/or management system 105 can start a new charge cycle by remeasuring the current throughput of multiple rechargeable energy storage systems 101 and by charging the rechargeable energy storage system that has the highest current throughput (when the current throughput charge protocol is used).

As mentioned above, communication module 102 is configured to analyze multiple rechargeable energy storage systems 101 according to the charge protocol for each charge cycle. To this end, communication module 102 can be configured to communicate with management systems 105 of multiple rechargeable energy storage systems 101 to retrieve data (e.g., current throughputs, states of charge, voltage differences, temperatures, etc.) from management systems 105 that pertains to their respective rechargeable energy storage systems of multiple rechargeable energy storage systems 101. Meanwhile, as part of this analysis, communication module 102 can be configured to perform comparisons of this data (e.g., current throughputs, states of charge, voltage differences, temperatures, etc.). For example, communication module 102 could compare current throughputs of multiple rechargeable energy storage systems 101 to determine a greatest current throughput of the current throughputs. Management systems 105 can be battery management systems.

As control system 100 cycles through each charge cycle, in some examples, communication module 102 may encounter a situation during a given charge cycle where multiple rechargeable energy storage systems 101 comprise a sub-group of rechargeable energy storage systems in which each rechargeable energy storage system of the sub-group is determined to be in a similar charge condition (e.g., each rechargeable energy storage system has approximately the same current throughput), but the sub-group exhibits a different charge condition (e.g., a different current throughput) than others of multiple rechargeable energy storage systems 101 (e.g., the different current throughput is greater than the current throughputs of the others). Accordingly, in some embodiments, control system 100 can be configured to proceed in either of two modes if such a condition exists. In the first mode, control system 100 can be configured to consider this situation to be one such predetermined condition causing control system 100 to apply a new charge protocol to all of multiple rechargeable energy storage systems 101 (e.g., moving from the current throughput charge protocol to the state of charge charge protocol) for this charge cycle. Alternatively, control system 100 can be configured to now treat the sub-group as if it were a new and smaller group of multiple rechargeable energy storage systems 101, thereby moving to the next charge protocol only within the relevant sub-group for this particular charge cycle. In some embodiments, this approach could continue for a second sub-group within the first sub-group, etc., as applicable. Upon completion of a charge cycle, control system 100 can then return to analyzing all of multiple rechargeable energy storage systems 101 for the following charge cycle using the first charge protocol.

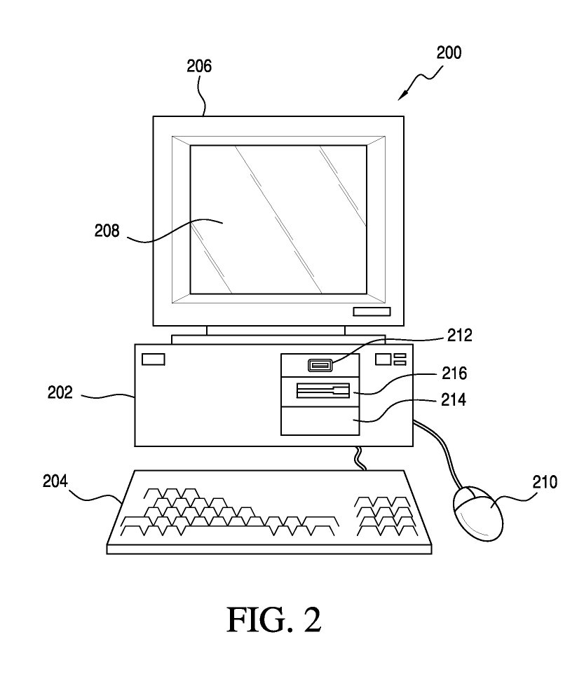

As mentioned above, control system 100 can comprise control computer system 106 and/or central computer system 107. Control computer system 106 and/or central computer system 107 can be configured to support/assist communication module 102 and/or control module 103 to perform any calculations, comparisons, etc., relevant to communication module 102 and/or control module 103 for performing their respective functions. Control computer system 106 and/or central computer system 107 can also function as a user interface through which a user can communicate with control system 100, such as, to select predetermined condition(s) and/or charge protocol(s) for control system 100. In many embodiments, control computer system 106 can be located at and/or can be part of control system 100 and/or control module 103. Meanwhile, central computer system 107 can be located apart from control module 103. Likewise, central computer system 107 may be part of control system 100 or it may be separate from but in communication with control system 100. Accordingly, in many embodiments, control computer system 106 can be part of computer system of control module 103 and/or charge system 104 while central computer system 107 can comprise an external and/or remote computer system of user(s) of control system 100 and/or operator(s) of multiple rechargeable energy storage systems 101. Accordingly, control computer system 106 and/or central computer system 107 can each be similar or identical to computer system 200 (FIG. 2), as described below.

In some embodiments, control system 100 could be modified to charge multiple sub-rechargeable energy storage systems (e.g., individual cells and/or modules) within a single rechargeable energy storage system.

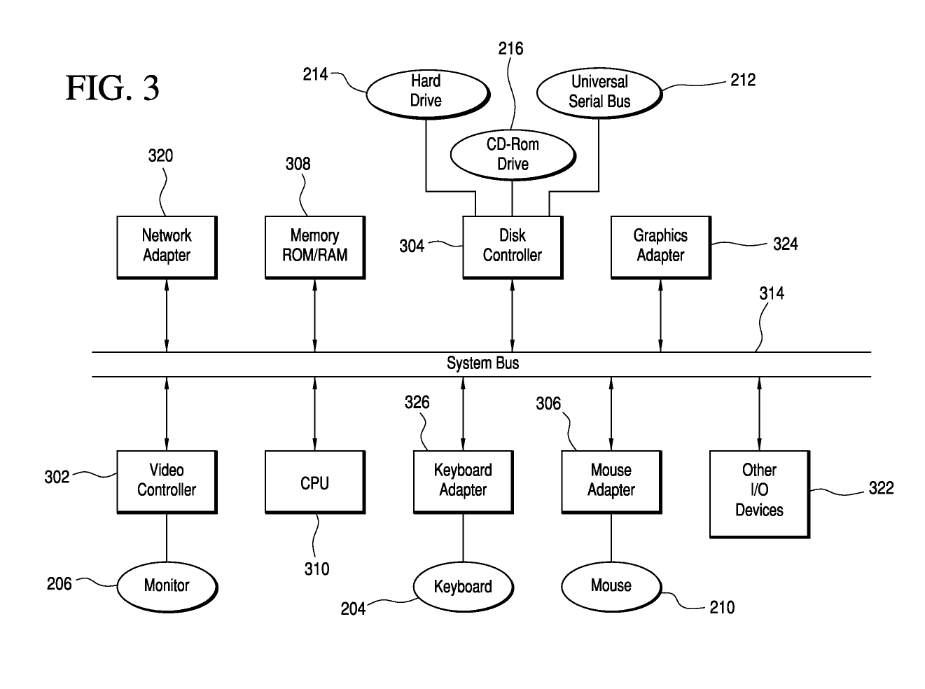

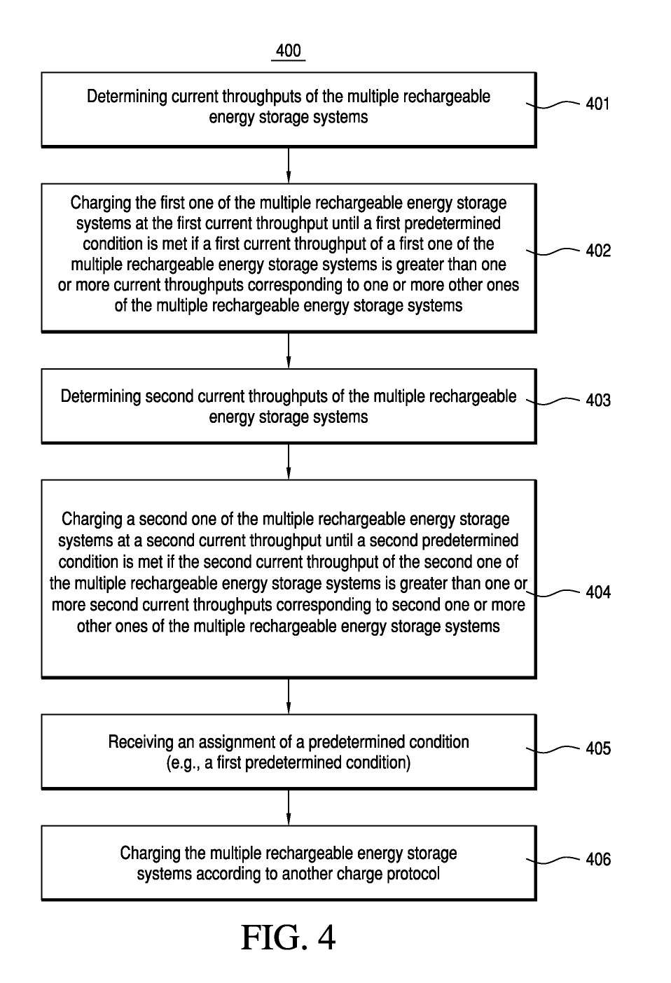

Turning to the next drawing, FIG. 2 illustrates an exemplary embodiment of computer system 200, all of which or a portion of which can be suitable for implementing an embodiment of control computer system 106 (FIG. 1), central computer system 107 (FIG. 1), and/or another part of control system 100 (FIG. 1) as well as any of the various procedures, processes, and/or activities of method 400 (FIG. 4). As an example, chassis 202 (and its internal components) can be suitable for implementing control computer system 106 (FIG. 1) and/or central computer system 107 (FIG. 1). Furthermore, one or more parts of computer system 200 (e.g., refreshing monitor 206, keyboard 204, and/or mouse 210, etc.) may also be appropriate for implementing control computer system 106 (FIG. 1) and/or central computer system 107 (FIG. 1). Computer system 200 includes chassis 202 containing one or more circuit boards (not shown), Universal Serial Bus (USB) 212, Compact Disc Read-Only Memory (CD-ROM) and/or Digital Video Disc (DVD) drive 216, and hard drive 214. A representative block diagram of the elements included on the circuit boards inside chassis 202 is shown in FIG. 2. Central processing unit (CPU) 310 in FIG. 3 is coupled to system bus 314 in FIG. 3. In various embodiments, the architecture of CPU 310 can be compliant with any of a variety of commercially distributed architecture families.

System bus 314 also is coupled to memory 308, where memory 308 includes both read only memory (ROM) and random access memory (RAM). Non-volatile portions of memory 308 or the ROM can be encoded with a boot code sequence suitable for restoring computer system 200 (FIG. 2) to a functional state after a system reset. In addition, memory 308 can include microcode such as a Basic Input-Output System (BIOS). In some examples, the one or more storage modules of the various embodiments disclosed herein can include memory 308, USB 212 (FIGS. 2-3), hard drive 214 (FIGS. 2-3), and/or CD-ROM or DVD drive 216 (FIGS. 2-3). In the same or different examples, the one or more storage modules of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Common operating systems for a mobile electronic device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 3, various I/O devices such as disk controller 304, graphics adapter 324, video controller 302, keyboard adapter 326, mouse adapter 306, network adapter 320, and other I/O devices 322 can be coupled to system bus 314. Keyboard adapter 326 and mouse adapter 306 are coupled to keyboard 204 (FIGS. 2-3) and mouse 210 (FIGS. 2-3), respectively, of computer system 200 (FIG. 2). While graphics adapter 324 and video controller 302 are indicated as distinct units in FIG. 3, video controller 302 can be integrated into graphics adapter 324, or vice versa in other embodiments. Video controller 302 is suitable for refreshing monitor 206 (FIGS. 2-3) to display images on a screen 208 (FIG. 2) of computer system 200 (FIG. 2). Disk controller 304 can control hard drive 214 (FIGS. 2-3), USB 212 (FIGS. 2-3), and CD-ROM drive 216 (FIGS. 2-3). In other embodiments, distinct units can be used to control each of these devices separately.

In some embodiments, network adapter 320 can be part of a WNIC (wireless network interface controller) card (not shown) plugged or coupled to an expansion port (not shown) in computer system 200. In other embodiments, the WNIC card can be a wireless network card built into computer system 200. A wireless network adapter can be built into computer system 200 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 320 can be a wired network adapter.

Although many other components of computer system 200 (FIG. 2) are not shown, such components and their interconnection are well known to those of ordinary skill in the art. Accordingly, further details concerning the construction and composition of computer system 200 and the circuit boards inside chassis 202 (FIG. 2) are not discussed herein.

When computer system 200 in FIG. 2 is running, program instructions stored on a USB-equipped electronic device connected to USB 212, on a CD-ROM or DVD in CD-ROM and/or DVD drive 216, on hard drive 214, or in memory 308 (FIG. 3) are executed by CPU 310 (FIG. 3). A portion of the program instructions, stored on these devices, can be suitable for carrying out at least part of control system 100 (FIG. 1) and/or method 400 (FIG. 4).

Although computer system 200 is illustrated as a desktop computer in FIG. 2, there can be examples where computer system 200 may take a different form factor while still having functional elements similar to those described for computer system 200. In some embodiments, computer system 200 may comprise a single computer, a single server, or a cluster or collection of computers or servers, or a cloud of computers or servers. Typically, a cluster or collection of servers can be used when the demand on computer system 200 exceeds the reasonable capability of a single server or computer.

Meanwhile, in some embodiments, control computer system 106 (FIG. 1) may not have the level of sophistication and/or complexity of central computer system 107 (FIG. 1). For example, control computer system 106 (FIG. 1) may only have those processing capabilities and/or memory storage capabilities as are reasonably necessary to support the functionality of communication module 102 and/or control module 103, described above with respect to control system 100 (FIG. 1). In these examples, control computer system 106 (FIG. 1) could simply be implemented as a microcontroller comprising flash memory, or the like. Reducing the sophistication and/or complexity of control computer system 106 (FIG. 1) can reduce the size and/or cost of implementing control system 100 (FIG. 1). Nonetheless, in other embodiments, control computer system 106 (FIG. 1) may need additional sophistication and/or complexity to operate as desired.

Skipping ahead in the drawings, FIG. 8 illustrates an exemplary embodiment of control system 800 operating to charge multiple rechargeable energy storage systems, each rechargeable energy storage system of the multiple rechargeable energy storage systems being part of one electric vehicle of electric vehicles 801. Control system 800 can be similar or identical to control system 100 (FIG. 1). The multiple rechargeable energy storage systems can be similar or identical to multiple rechargeable energy storage systems 101 (FIG. 1). Electric vehicles 801 can comprise electric vehicle 802 and/or electric vehicle 803. Accordingly, electric vehicle 801 can comprise a first rechargeable energy storage system of the multiple rechargeable energy storage systems, and electric vehicle 802 can comprise a second rechargeable energy storage system of the multiple rechargeable energy storage systems. Control system 800 can comprise charge system 804. Charge system 804 can be similar or identical to charge system 104 (FIG. 1). Charge system 104 can be configured to be coupled at electric vehicle 801 and/or electric vehicle 802 to charge the first rechargeable energy storage system and the second rechargeable energy storage system as described above with respect to control system 100 (FIG. 1).

Returning now to the drawings, FIG. 4 illustrates a flow chart for an embodiment of method 400 for charging multiple rechargeable energy storage systems. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of the method 400 can be performed in any other suitable order. In still other embodiments, one or more of the procedures, the processes, and/or the activities in method 400 can be combined or skipped. The multiple rechargeable energy storage systems can be similar or identical to multiple rechargeable energy storage systems 101 (FIG. 1).

Referring to FIG. 4, method 400 comprises procedure 401 of determining current throughputs of the multiple rechargeable energy storage systems. Procedure 401 can comprise determining current throughputs of the multiple rechargeable energy storage systems with a communication module. The communication module can be similar or identical to communication module 102 (FIG. 1). In some embodiments, performing procedure 401 can be similar or identical to determining current throughputs of the multiple rechargeable energy storage systems, as described above with respect to control system 100 (FIG. 1).

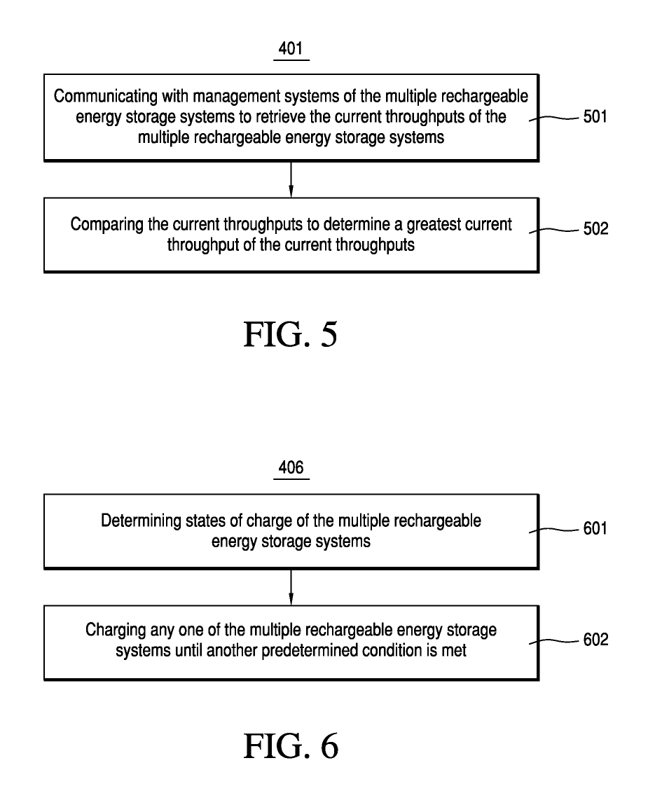

Turning to the next drawing, FIG. 5 illustrates a flow chart for an exemplary embodiment of procedure 401 of determining current throughputs of the multiple rechargeable energy storage systems, according to the embodiment of FIG. 4.

As illustrated in FIG. 5, procedure 401 can comprise process 501 of communicating with management systems of the multiple rechargeable energy storage systems to retrieve the current throughputs of the multiple rechargeable energy storage systems. The management systems can be similar or identical to management systems 105 (FIG. 1). In many embodiments, performing process 501 can be similar or identical to communicating sequentially with management systems of the multiple rechargeable energy storage systems, as described above with respect to control system 100 (FIG. 1).

Next, procedure 401 also can comprise process 502 of comparing the current throughputs to each other to determine a greatest current throughput of the current throughputs. Process 502 can be performed by the communication module and/or the control module, as described above with respect to control system 100 (FIG. 1).

Returning now to FIG. 4, if a first current throughput of a first one of the multiple rechargeable energy storage systems is greater than one or more current throughputs corresponding to one or more other ones (or all of the other ones) of the multiple rechargeable energy storage systems, method 400 continues with procedure 402 of charging the first one of the multiple rechargeable energy storage systems at the first current throughput until a first predetermined condition is met. As an example, in some embodiments, the first predetermined condition can be similar or identical to the predetermined time interval(s) described above with respect to control system 100 (FIG. 1). As another example, in other embodiments, the predetermined condition (and/or procedure 402) can comprise using the communication module and/or a control module to determine if the first current throughput of the first one of the multiple rechargeable energy storage systems is greater than one or more current throughputs corresponding to one or more other ones of the multiple rechargeable energy storage systems. The control module can be similar or identical to control module 103 (FIG. 1). Performing procedure 402 can be similar or identical to charging the first one of the multiple rechargeable energy storage systems at the first current throughput until the first predetermined condition is met, as described above with respect to control system 100 (FIG. 1).

In some embodiments, procedure 402 can be performed if the first current throughput is no less than any other current throughputs of the current throughputs of the multiple rechargeable energy storage systems. In the same or different embodiments, procedure 402 can comprise charging the first one of the multiple rechargeable energy storage systems at the first current throughput with a charge system such that current throughput for the multiple rechargeable energy storage systems is maximized.

Method 400 can comprise procedure 403 of determining second current throughputs of the multiple rechargeable energy storage systems. In many embodiments, procedure 403 can occur after procedure 402. Performing procedure 403 can be similar or identical to repeating procedure 401, but for a subsequent charge cycle, as described above with respect to control system 100 (FIG. 1).

Furthermore, if a second current throughput of a second one of the multiple rechargeable energy storage systems is greater than one or more second current throughputs corresponding to second one or more other ones of the multiple rechargeable energy storage systems, method 400 can comprise procedure 404 of charging the second one of the multiple rechargeable energy storage systems at the second current throughput until a second predetermined condition is met. In some embodiments, the second one of the multiple rechargeable energy storage systems can comprise the first one of the multiple rechargeable energy storage systems of procedure 402 if the first one of the multiple rechargeable energy storage systems comprises the second current throughput. In other embodiments, the second one or more other ones of the multiple rechargeable energy storage systems can comprise the first one of the multiple rechargeable energy storage systems. In many embodiments, procedure 404 can occur after procedure 403. Performing procedure 404 can be similar or identical to repeating procedure 402, but for the subsequent charge cycle, as described above with respect to control system 100 (FIG. 1) and referenced with respect to procedure 403.

In many embodiments, procedure 401 and/or procedure 402 can occur before procedure 403 and/or procedure 404. That is to say, in various embodiments, procedures 401 and 402 can be grouped into a first charge cycle, and procedures 403 and 404 can be grouped into a second or subsequent charge cycle. In many examples, procedures 401 and 402 can be cyclically mirrored for however many charging cycles are appropriate. In some embodiments, procedure 401 can occur before procedure 402 and/or can be repeated as many times as desired while performing procedure 402, and procedures 403 and 404 can mirror this arrangement, as well.

Method 400 can comprise procedure 405 of receiving an assignment of a predetermined condition (e.g., a first predetermined condition). In many embodiments, procedure 405 can occur before procedures 401-404. In the same or different embodiments, the first instance and/or other instances of procedure 405 can occur during procedures 401-404. In some embodiments, procedure 405 can comprise receiving the assignment of the first predetermined condition from a control computer system and/or a central computer system. The control computer system can be similar or identical to control computer system 106 (FIG. 1), and/or the central computer system can be similar or identical to central computer system 107 (FIG. 1). In some embodiments, procedure 405 can be omitted.

Next, if the maximum (e.g., highest) current throughputs are approximately equal to each other and/or if the multiple rechargeable energy storage systems remain able to be charged, method 400 can comprise procedure 406 of charging the multiple rechargeable energy storage systems according to another charge protocol. Procedure 406 can occur after procedure 401 and/or procedure 402 and before and/or after procedure 403 and/or procedure 404. The other charge protocol can be similar or identical to any of the other charge protocol(s) described above with respect to control system 100 (FIG. 1). Like for procedures 402 and 404, procedure 406 can be repeated, as desired. In some embodiments, procedure 406 can be omitted.

Returning again to the drawings, FIG. 6 illustrates a flow chart for an exemplary embodiment of procedure 406 of charging the multiple rechargeable energy storage systems according to the another charge protocol, according to the embodiment of FIG. 4.

As illustrated in FIG. 6, procedure 406 can comprise process 601 of determining states of charge of the multiple rechargeable energy storage systems. In some embodiments, performing procedure 601 can be similar or identical to determining states of charge of the multiple rechargeable energy storage systems as described above with respect to control system 100 (FIG. 1).

Next, if a state of charge of any one of the multiple rechargeable energy storage systems is greater than one or more states of charge of any one or more other ones of the multiple rechargeable energy storage systems, procedure 406 can continue with process 602 of charging the any one of the multiple rechargeable energy storage systems until another predetermined condition is met. Process 601 can be performed in a similar manner to procedure 401, but with respect to states of charge rather than to current throughputs. In some embodiments, the predetermined condition of procedure 406 can be similar or identical to the predetermined condition of procedure 402 and/or procedure 404, or can be different. In any event, the predetermined condition of procedure 406 may be similar or identical to any predetermined condition(s) referenced above with respect to control system 100 (FIG. 1).

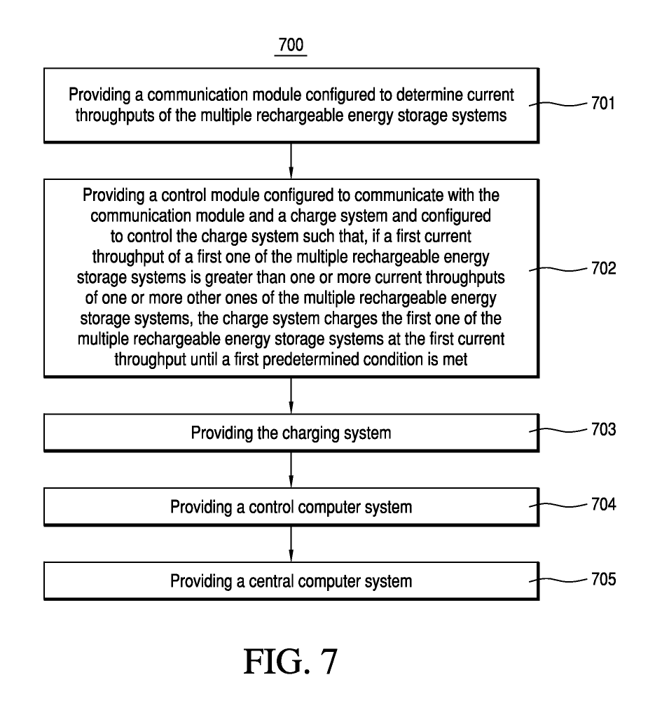

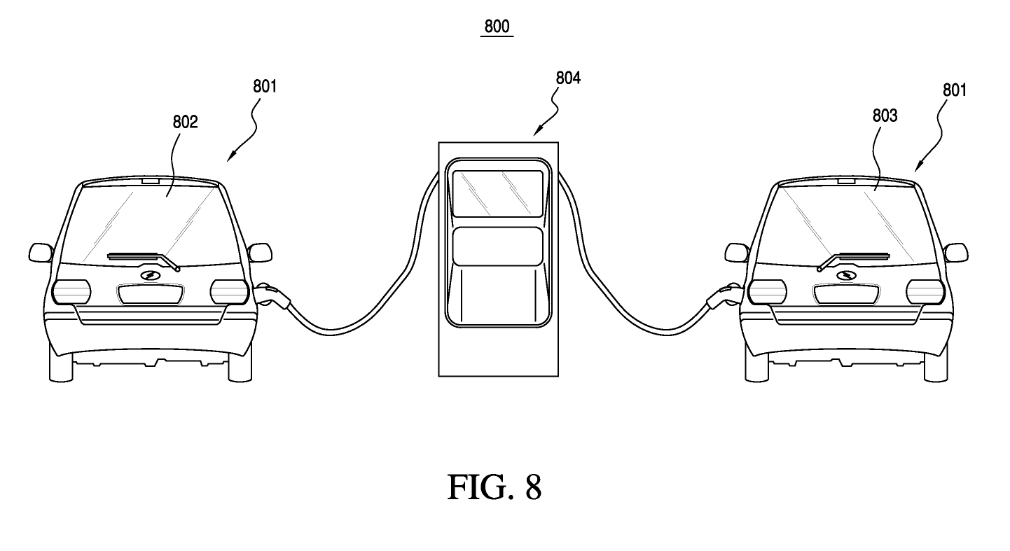

FIG. 7 illustrates a flow chart for an embodiment of method 700 of providing a control system for charging multiple rechargeable energy storage systems. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of the method 700 can be performed in any other suitable order. In still other embodiments, one or more of the procedures, the processes, and/or the activities in method 700 can be combined or skipped. The multiple rechargeable energy storage systems can be similar or identical to multiple rechargeable energy storage systems 101 (FIG. 1).

Referring to FIG. 7, method 700 comprises procedure 701 of providing a communication module configured to determine current throughputs of the multiple rechargeable energy storage systems. The communication module can be similar or identical to communication module 102 (FIG. 1).

Method 700 also comprises procedure 702 of providing a control module configured to communicate with the communication module and a charge system and configured to control the charge system such that, if a first current throughput of a first one of the multiple rechargeable energy storage systems is greater than one or more current throughputs of one or more other ones of the multiple rechargeable energy storage systems, the charge system charges the first one of the multiple rechargeable energy storage systems at the first current throughput until a first predetermined condition is met. The control system can be similar or identical to control system 103 (FIG. 1).

Method 700 can further comprise procedure 703 of providing the charge system. The charge system can be similar or identical to charge system 104 (FIG. 1). In some embodiments of method 700, procedure 703 can include procedure 701 and/or procedure 702.

Method 700 can additionally comprise procedure 704 of providing a control computer system. The control computer system can be similar or identical to control computer system 106 (FIG. 1). In some embodiments of method 700, procedure 704 can be part of procedure 702 and/or procedure 703.

Method 700 also can comprise procedure 705 of providing a central computer system. The central computer system can be similar or identical to central computer system 107 (FIG. 1).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 401-406 of FIG. 4, processes 501-502 of FIG. 5, processes 601-602 of FIG. 6, and procedures 701-705 of FIG. 7 may be comprised of many different procedures, processes, and activities and be performed by many different modules, in many different orders, that any element of FIGS. 1-7 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method for charging multiple rechargeable energy storage systems, the method comprising:
determining current throughputs of the multiple rechargeable energy storage systems; and
if a first current throughput of a first one of the multiple rechargeable energy storage systems is greater than one or more current throughputs corresponding to one or more other ones of the multiple rechargeable energy storage systems, charging the first one of the multiple rechargeable energy storage systems at the first current throughput until a first predetermined condition is met.

2) The method of claim 1 wherein:
the first predetermined condition comprises at least one of:
a predetermined interval of time elapses;
the first current throughput declines by a predetermined percentage, the percentage being greater than or equal to approximately five percent and less than or equal to approximately twenty percent;
the first current throughput declines by a predetermined amount;
the first current throughput approximately equals each current throughput of the other current throughputs; or
another rechargeable energy storage system is added to the multiple rechargeable energy storage systems.

3) The method of claim 2 wherein:
the predetermined interval of time is greater than or equal to approximately five minutes and less than or equal to approximately fifteen minutes.

4) The method of claim 1 further comprising:
after the first predetermined condition is met, determining second current throughputs of the multiple rechargeable energy storage systems; and
after determining the second current throughputs of the multiple rechargeable energy storage systems, if a second current throughput of a second one of the multiple rechargeable energy storage systems is greater than one or more second current throughputs corresponding to second one or more other ones of the multiple rechargeable energy storage systems, charging the second one of the multiple rechargeable energy storage systems at the second current throughput until a second predetermined condition is met,
wherein:
the second one of the multiple rechargeable energy storage systems comprises the first one of the multiple rechargeable energy storage systems if the first one of the multiple rechargeable energy storage systems comprises the second current throughput and, otherwise, the second one or more other ones of the multiple rechargeable energy storage systems comprise the first one of the multiple rechargeable energy storage systems.

5) The method of claim 1 further comprising:
receiving an assignment of the first predetermined condition.

6) The method of claim 1 wherein:
determining the current throughputs of the multiple rechargeable energy storage systems comprises comparing the current throughputs to each other to determine a greatest current throughput of the current throughputs.

7) The method of claim 1 wherein:
determining the current throughputs of the multiple rechargeable energy storage systems comprises communicating with management systems of the multiple rechargeable energy storage systems to retrieve the current throughputs of the multiple rechargeable energy storage systems.

8) The method of claim 1 further comprising:
if highest ones of the current throughputs are approximately equal to each other and if the multiple rechargeable energy storage systems remain able to be charged, charging the multiple rechargeable energy storage systems according to an other charge protocol.

9) The method of claim 8 wherein:
charging the multiple rechargeable energy storage systems according to the other charge protocol comprises:
determining states of charge of the multiple rechargeable energy storage systems; and
if a state of charge of any one of the multiple rechargeable energy storage systems is greater than one or more states of charge of any one or more other ones of the multiple rechargeable energy storage systems, charging the any one of the multiple rechargeable energy storage systems until an other predetermined condition is met.

10) The method of claim 9 wherein:
determining the states of charge of the multiple rechargeable energy storage systems comprises communicating with management systems of the multiple rechargeable energy storage systems to retrieve the states of charge of the multiple rechargeable energy storage systems.

11) The method of claim 8 wherein:
charging the first one of the multiple rechargeable energy storage systems at the first current throughput until the first predetermined condition is met occurs before charging the multiple rechargeable energy storage systems according to the other charge protocol if the current throughputs are equal and the multiple rechargeable energy storage systems remain able to be charged.

12) The method of claim 1 wherein:
charging the first one of the multiple rechargeable energy storage systems at the first current throughput until the first predetermined condition is met comprises charging the first one of the multiple rechargeable energy storage systems at the first current throughput until the first predetermined condition is met if the first current throughput is no less than any other current throughputs of the current throughputs of the multiple rechargeable energy storage systems.

13) The method of claim 1 wherein:
each rechargeable energy storage system of the multiple rechargeable energy storage systems is configured to provide electricity to an electric vehicle.

14) A control system for charging multiple rechargeable energy storage systems, the control system comprising:
a communication module configured to determine current throughputs of the multiple rechargeable energy storage systems; and
a control module configured to communicate with the communication module and a charge system and configured to control the charge system such that, if the first current throughput of the first one of the multiple rechargeable energy storage systems is greater than one or more current throughputs of one or more other ones of the multiple rechargeable energy storage systems, the charge system charges a first one of the multiple rechargeable energy storage systems at a first current throughput until a first predetermined condition is met.

15) The control system of claim 14 wherein:
the first predetermined condition comprises at least one of:
a predetermined interval of time elapses;
the first current throughput declines by a predetermined percentage, the percentage being greater than or equal to approximately five percent and less than or equal to approximately twenty percent;
the first current throughput declines by a predetermined amount;
the first current throughput approximately equals each current throughput of the other current throughputs; or
another rechargeable energy storage system is added to the multiple rechargeable energy storage systems.

16) The control system of claim 15 wherein:
the predetermined interval of time is greater than or equal to approximately five minutes and less than or equal to approximately fifteen minutes.

17) The control system of claim 14 wherein:
the communication module is further configured to determine second current throughputs of the multiple rechargeable energy storage systems after the first predetermined condition is met;
the control module is configured to control the charge system such that, if a second current throughput of a second one of the multiple rechargeable energy storage systems is greater than one or more second current throughputs corresponding to second one or more other ones of the multiple rechargeable energy storage systems, the charge system charges the second one of the multiple rechargeable energy storage systems at the second current throughput until a second predetermined condition is met; and
the second one of the multiple rechargeable energy storage systems comprises the first one of the multiple rechargeable energy storage systems if the first one of the multiple rechargeable energy storage systems comprises the second current throughput and, otherwise, the second one or more other ones of the multiple rechargeable energy storage systems comprise the first one of the multiple rechargeable energy storage systems.

18) The control system of claim 14 wherein at least one of:
the communication module is configured to receive an assignment of the first predetermined condition;
the communication module is configured to compare the current throughputs to determine a greatest current throughput of the current throughputs; or
the communication module is configured to communicate with management systems of the multiple rechargeable energy storage systems to retrieve the current throughputs of the multiple rechargeable energy storage systems in order to determine the current throughputs of the multiple rechargeable energy storage systems.

19) The control system of claim 14 wherein:
the control module is configured to control the charge system such that, if highest ones of the current throughputs are approximately equal to each other and if the multiple rechargeable energy storage systems remain able to be charged, the charge system charges the multiple rechargeable energy storage systems according to an other charge protocol.

20) The control system of claim 19 wherein:
the communication module is configured to determine states of charge of the multiple rechargeable energy storage systems when the control module controls the charge system according to the other charge protocol; and
the control module is configured to control the charge system such that, if a state of charge of any one of the multiple rechargeable energy storage systems is greater than one or more states of charge corresponding to any one or more other ones of the multiple rechargeable energy storage systems, the charge system charges the any one of the multiple rechargeable energy storage systems until an other predetermined condition is met, when the control module controls the charge system according to the other charge protocol.

21) The control system of claim 16 wherein:
the control module is configured to control a charge system such that, before the control module controls the charge system according to the other charge protocol, the charge system charges the first one of the multiple rechargeable energy storage systems at the first current throughput until the first predetermined condition is met.

22) The control system of claim 14 wherein at least one of:
the control system comprises the charge system;
the charge system comprises the control module;
the control system comprises a control computer system; or
the control system is configured to communicate with a central computer system.

23) The method of claim 14 wherein:
each rechargeable energy storage system of the multiple rechargeable energy storage systems is configured to provide electricity to an electric vehicle.

24) A method of providing a control system for charging multiple rechargeable energy storage systems, the method comprising:
providing a communication module configured to determine current throughputs of the multiple rechargeable energy storage systems; and
providing a control module configured to communicate with the communication module and a charge system and configured to control the charge system such that, if a first current throughput of a first one of the multiple rechargeable energy storage systems is greater than one or more current throughputs of one or more other ones of the multiple rechargeable energy storage systems, the charge system charges the first one of the multiple rechargeable energy storage systems at the first current throughput until a first predetermined condition is met.

25) The method of claim 24 wherein:
the first predetermined condition comprises at least one of:
a predetermined interval of time elapses;
the first current throughput declines by a predetermined percentage, the percentage being greater than or equal to approximately five percent and less than or equal to approximately twenty percent;
the first current throughput declines by a predetermined amount;
the first current throughput approximately equals each current throughput of the other current throughputs; or
another rechargeable energy storage system is added to the multiple rechargeable energy storage systems.

26) The method of claim 25 wherein:
the interval of time is greater than or equal to approximately five minutes and less than or equal to approximately fifteen minutes.

27) The method of claim 26 wherein:
the communication module is further configured to determine second current throughputs of the multiple rechargeable energy storage systems after the first predetermined condition is met; and
the control module is configured to control the charge system such that, if a second current throughput of a second one of the multiple rechargeable energy storage systems is greater than one or more second current throughputs corresponding to second one or more other ones of the multiple rechargeable energy storage systems, the charge system charges the second one of the multiple rechargeable energy storage systems at the second current throughput until a second predetermined condition is met; and
the second one of the multiple rechargeable energy storage systems comprises the first one of the multiple rechargeable energy storage systems if the first one of the multiple rechargeable energy storage systems comprises the second current throughput and, otherwise, the second one or more other ones of the multiple rechargeable energy storage systems comprise the first one of the multiple rechargeable energy storage systems.

28) The method of claim 26 wherein at least one of:
the communication module is configured to receive an assignment of the first predetermined condition;
the communication module is configured to compare the current throughputs to determine a greatest current throughput of the current throughputs; or
the communication module is configured to communicate with management systems of the multiple rechargeable energy storage systems to retrieve the current throughputs of the multiple rechargeable energy storage systems in order to determine the current throughputs of the multiple rechargeable energy storage systems.

29) The method of claim 24 wherein:
the control module is configured to control the charge system such that, if highest ones of the current throughputs are approximately equal to each other and the multiple rechargeable energy storage systems remain able to be charged, the charge system charges the multiple rechargeable energy storage systems according to another charge protocol.

30) The method of claim 29 wherein:
the communication module is configured to determine states of charge of the multiple rechargeable energy storage systems when the control module controls the charge system according to the other charge protocol; and
the control module is configured to control the charge system such that, if a state of charge of any one of the multiple rechargeable energy storage systems is greater than one or more states of charge corresponding to any one or more other ones of the multiple rechargeable energy storage systems, the charge system charges the only one of the multiple rechargeable energy storage systems until an other predetermined condition is met, when the control module controls the charge system according to the other charge protocol.

31) The method of claim 24 wherein:
the control module is configured to control a charge system such that, before the control module controls the charge system according to the other charge protocol, the charge system charges the first one of the multiple rechargeable energy storage systems at the first current throughput until the first predetermined condition is met.

32) The method of claim 24 further comprising at least one of:
providing the charge system; or
providing a control computer system, wherein the control system comprises the control computer system.

33) The method of claim 24 wherein at least one of:
each rechargeable energy storage system of the multiple rechargeable energy storage systems is configured to provide electricity to an electric vehicle; or
the control system is configured to communicate with a central computer system.
